(19) United States
(12) Patent Application Publication
(10) Pub. No.: US 2011/0207596 A1
(43) Pub. Date: Aug. 25, 2011

(54) Method for Producing a Packing Structure with Control Over Hydrothermal Synthesis Parameters

(75) Inventors: Pascal Del-Gallo, Dourdan (FR); Emmanuel Baune, Maffliers (FR); Jerome Cantonnet, Brive (FR)

(73) Assignee: L'Air Liquide Societe Anonyme Pour L'Etude Et L'Exploitation Des Procedes Georges Claude, Paris (FR)

(21) Appl. No.: 13/000,547

(22) PCT Filed: May 29, 2009
(86) PCT No.: PCT/FR2009/051017

§ 371 Date: Dec. 21, 2010

(30) Foreign Application Priority Data
Jul. 2, 2008 (FR) 0854501

(51) Int. Cl. C04B 35/22

(52) U.S. Cl. 501/154

(57) ABSTRACT

The invention relates to a method for producing a packing structure, characterized in that it includes the following steps: a) a step in which the temperature of an initial mixture of quicklime and silica is raised to a temperature T1 of between 150 and 300° C. over a period of less than 10 hours; b) a step in which hydrothermal synthesis is performed using the mixture of quicklime and silica produced in step (a) at a temperature T1 of between 150 and 300° C. and at a pressure P1 of between 5×10⁵ Pa and 25×10⁵ Pa over a period t1 of between 10 and 70 hours; c) a step in which the mixture produced in step (b) is cooled from temperature T1 to ambient temperature over a period of between 1 and 48 hours at a cooling rate ΔTR1 of between 3 and 200° C./hour; and d) a step in which the mixture produced in step (c) is dried.

The subject of the present invention is novel packing structures and their production process that are characterized in that the hydrothermal synthesis step is controlled by its operating parameters, namely the temperature, the time to rise to this temperature, the pressure, the time to synthesize silico-calcareous ceramic packings and the temperature drop time.

It is known to use containers under pressure, containing gases such as acetylene, dissolved in a solvent such as acetone, in various medical and artisanal applications and especially to carry out welding, brazing and heating operations together with an oxygen bottle.

These containers are usually packed with solid filling materials intended to stabilize the gases that they contain, which are thermodynamically unstable under the effect of variations in pressure or temperature, and therefore liable to decompose during their storage, transport and/or distribution.

These materials must be sufficiently porous so as to make it easy to fill and release the gases contained in the container. They must also be incombustible and inert with respect to these gases and have good mechanical strength. These materials conventionally consist of porous silico-calcareous ceramic substances obtained for example from a homogeneous mixture, in water of quicklime or milk of lime and silica (especially in the form of quartz flour), as described in the documents WO-A-93/16011, WO-A-98/29682 and EP-A-262031, so as to form a slurry, which then undergoes a hydrothermal synthesis. Specifically, the slurry is introduced into the container to be packed, under a partial vacuum, which is then autoclaved at a certain pressure and temperature, and then dried in an oven so as to completely remove the water and form a monolithic solid mass of composition CaₓSi_{y}O_{z},wH₂O_, having crystalline structures of the tobermorite and xonotlite type, possibly with residual quartz present. Various additives may be introduced into these mixtures of the prior art in order to improve the dispersion of the lime and silica and thus avoid forming structural inhomogeneities and shrinkage phenomena observed during the hardening of the porous mass. The filler materials obtained must in fact have a homogeneous porosity with no empty spaces, within the material and between the material and the container, in which empty spaces gas pockets could accumulate and run the risk of causing an explosion.

Document EP-A-264550 also indicates that a porous mass containing at least 50%, or at least 65% or even at least 75% by weight of crystalline phase (with respect to the weight of calcium silicate) makes it possible to meet the two requirements of compressive strength and resistance to shrinkage at the hydrothermal synthesis and firing temperatures.

Although the known porous masses are generally satisfactory from the standpoint of their mechanical strength, the fact remains that the properties of withdrawing gases trapped in these porous masses are at the present time insufficient and/or completely random. This random aspect is due to the lack of control of the phases formed and of the microstructure of the porous mass, due to the lack of control/understanding of the process and especially the hydrothermal synthesis step by controlling the operating parameters, namely the temperature rise rate, the synthesis temperature, the duration of the temperature hold and control of the cooling rate.

Indeed, depending on the operating conditions of the bottles (use temperature, work rate, amount of gas contained in the bottle, etc.), they do not always allow the gas that they contain to be continuously withdrawn, at a high flow rate, throughout the duration needed for certain applications, especially welding applications, with a maximum gas recovery rate, corresponding to the ratio of the amount of gas that can be used to the amount of gas initially stored. Now, it would be desirable to be able to satisfy a flow rate of 200 l/h continuously for 15 minutes and a peak flow rate of 400 l/h for 4 minutes, for a gas capacity equal to or greater than 50% at the start of the test (defined as the ratio of the amount of gas present at this instant to the amount of gas initially loaded into the container), the container having a diameter/length ratio of between 0.2 and 0.7, preferably between 0.35 and 0.5, for a minimum water capacity of one liter and preferably between 3 and 50 liters.

This insufficiency is due in particular to the thermal loss associated with extracting the gas from the solvent, which may prove to be very prejudicial to gas withdrawal. This thermal loss is not due mainly to the intrinsic conductivity of the silico-calcareous material (as a reminder, the void content is between 87 and 92%) but to the size (dimensions) of the needle-shaped crystals constituting the porous mass. This is because the smaller their size, (i) the larger the number of points of contact between them and ii) lower the d₅₀ of the pore size distribution (d₅₀ is defined as the average spread of the pore distribution). This therefore handicaps conductive heat transfer, leading to a relatively long period of “unavailability of the bottle”. This effect is to be correlated with the pore distribution. In the case of an acetylene bottle for example, the energy consumption is of the order of 600 joules per gram of acetylene extracted from the solvent. In practice, this results in the bottle being cooled considerably during withdrawal, leading to greater solubilization of the acetylene in the solvent and thus a drop in pressure, with repercussions on the withdrawal rate. The flow is finally exhausted when the pressure at the bottle outlet falls below atmospheric pressure.

Moreover, the temperature and pressure variations are not homogeneous within the container, which may lead to the appearance of mechanical stresses liable to degrade the porous mass over the course of time.

Added to the withdrawal difficulties are therefore mechanical strength problems liable to have safety repercussions.

Starting from this situation, one problem that arises is to provide a packing structure having satisfactory withdrawal properties and mechanical properties meeting the concerns for safety, and a process for producing such a structure.

One solution of the invention is a container packing structure comprising a crystalline phase containing 55 to 97% by weight of xonotlite crystallites and 3 to 45% by weight of tobermorite crystallites, characterized in that it comprises less than 15% by weight of intermediates of formula CaₓSi_{y}O_{z}, w H₂O with 1<x<16, 1<y<24, 4<z<60 and 1<w<18, including less than 5% by weight of CaCO₃ and less than 5% by weight de SiO₂, and in that said packing structure is homogeneous.

The term “homogeneous” is understood to means that various samples taken locally at various points in the packing structure (for example axially at the top, at the center and at the bottom, and radially at the center (core of the mass) and close to the metal wall, etc.) give homogeneous analysis (X-ray diffraction, porosity, pore size distribution) results, that is to say each quantitative measurement differs from one region to another by no more than 10%.

This “homogeneous” character is important as it determines the homogeneity of the solvent-acetylene solution in the case of an acetylene bottle, and consequently the uniformity of the local fill factors over the entire volume of the container enclosing the packing structure. If the microstructure is not homogeneous within the mass, excess pressure is created locally in zones where the fill factor is greater than the nominal fill factor of the bottle. For example, simulations have shown that at 35° C. the pressure in a bottle could be shifted from 22.3 bar to 24 bar by taking as assumption a fill factor of 30% higher than the nominal fill factor for ⅓ of the volume of the mass.

Xonotlite is a calcium silicate of formula Ca₆Si₆O₁₇(OH)₂, which has repeat units consisting of three tetrahedra. Moreover, tobermorite is also a calcium silicate, of formula Ca₅Si₆(0,OH)_{18.}5H₂O, crystallized in orthorhombic form.

The most generally accepted mechanism of xonotlite formation from the precursors CaO and SiO₂, in a CaO/SiO₂ molar ratio of about 1, in the presence of water is the following:

CaO/SiO₂/H₂O→Ca(OH)₂/SiO₂/H₂O→C—S—H gel→tobermorite→xonotlite.

The intermediate phases together preferably represent 0 to 10%, and more preferably 0 to 5%, of the weight of the crystalline phase finally present in the packing structure.

Calcium carbonate and silica each represent preferably less than 3% of the total weight of these crystalline phases.

Depending on the case, the packing structure may have one of the following characteristics:
the crystallites are in the form of mutually entangled needles. The needles have a width of between 1 and 10 μm, a length of between 1 and 20 μm and a thickness of less than 5 μm, preferably less than 1 μm;
said packing structure contains at least 70% by weight of crystalline phase;
the crystallites are linked together so as to provide between them a pore diameter D₉₅ greater than or equal to 0.4 μm and less than 5 μm and a mean pore diameter D₅₀ greater than or equal to 0.4 μm and less than 1.5 μm;
said packing structure has a compressive strength of greater than 15 kg/cm² i.e. 1.5 MPa. Its strength is preferably greater than 20 kg/cm², i.e. 2 MPa;
the crystallites are linked together so as to provide between them a pore diameter D₉₅ (the diameter at which 95% by volume of the pores have a smaller diameter) greater than or equal to 0.4 μm and less than 5 μm and a mean pore diameter D₅₀ (the diameter at which 50% by volume of the pores have a smaller diameter) greater than or equal to 0.4 μm and less than 1.5 μm.

Advantageously, the packing structure has a total open porosity of between 80% and 92%. These values may all be measured by mercury porosimetry. It should be noted that the pore distribution is the result of the size of the crystallites and of their stacking, and therefore in large part the result of the hydrothermal synthesis conditions.

The compressive strength may be measured by taking a 100×100 mm² cube from the packing structure and applying, between two faces, a compressive force. The mechanical strength corresponds to the pressure (in kg/cm² or MPa) above which the material starts to crack.

By using a packing structure according to the invention it is possible to achieve the desired withdrawal rate, while still meeting the requirements in terms of safety and mechanical strength.

Apart from the crystalline phase described above, the packing structure according to the invention may comprise fibers chosen from carbon-based synthetic fibers, such as those described in particular in the document U.S. Pat. No. 3,454,362, alkaline-resistant glass fibers, such as those described in particular in document U.S. Pat. No. 4,349,643, partially delignified cellulose fibers, such as those described in particular in document EP-A-262 031, and mixtures thereof, without this list being exhaustive. These fibers are useful possibly as reinforcing materials, to improve the impact strength of the packing structure, and also make it possible to avoid cracking problems while the structure is being dried. Their role is also to present seeding/nucleation sites on which the xonotlite needles start to grow. These fibers may be used as such, or after treatment of their surface.

The packing structure may also include dispersing agents and/or binders, such as cellulose derivatives, particularly carboxymethylcellulose, hydroxypropylcellulose or ethylhydroxyethylcellulose, polyethers, such as polyethylene glycol, smectite-type synthetic clays, amorphous silica with a specific surface area of advantageously between 150 and 300 m²/g, and mixtures thereof, without this list being exhaustive.

Preferably, the packing structure contains fibers, in particular carbon and/or glass and/or cellulose fibers. The amount of fibers is advantageously less than 55% by weight, relative to all of the solid precursors employed in the process for producing the packing structure. Preferably, the amount is between 1 and 20% by weight.

In this context, and to achieve the specific porous structure described above, one subject of the present invention is a process for producing the packing structure, characterized in that it comprises the following steps:

a) a temperature rise step, over a time of less than 10 h, during which an initial mixture of quicklime and silica is heated to a temperature T₁ of between 150 and 300° C.;
b) a hydrothermal synthesis step carried out:
using the quicklime/silica mixture resulting from step a),
at a temperature T₁ of between 150 and 300° C.,
at a pressure P₁ of between 5×10⁵ Pa and 25×10⁵ Pa and
for a time t₁ of between 10 h and 70 h;
   c) a cooling step, over a time of between 1 and 48 h, in which the mixture obtained from step b) is cooled from the temperature T₁ to room temperature at a cooling rate ΔTR₁ of between 3 and 200° C./hour;
   d) a drying step, in which the mixture obtained from step c) is dried.

Under certain conditions, step c) may be reduced to a sudden cooling of the porous masses, being characterized by the bottles shrinking at the end of the step b) and being quenched in a tank of cold water or passing beneath water jets for a time of between 1 minute and 1 hour.

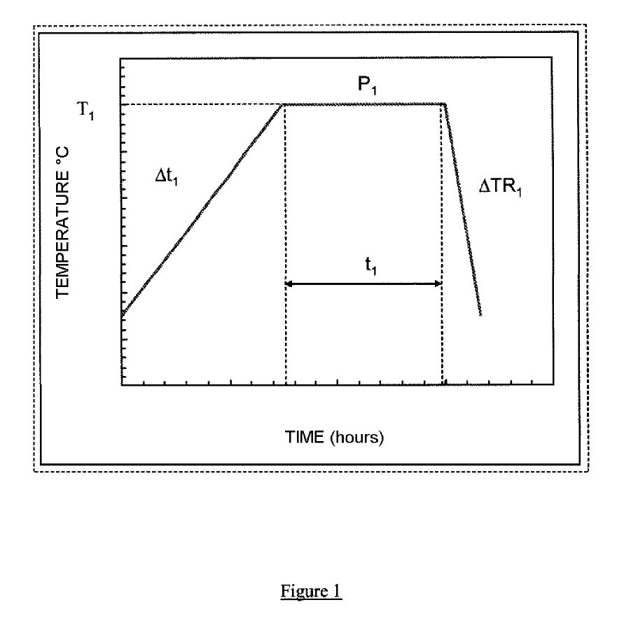

FIG. 1 shows schematically the operating conditions of the hydrothermal synthesis step of the process for producing the packing structure.

Depending on the case, the production process may have one of the following features:

in step a), the temperature rise takes place over a time Δt₁ of less than 2 h; in step b), the temperature T₁ is between 180 and 250° C.; and in step c), the pressure P₁ is between 7×10⁵ Pa and 25×10⁵ Pa. The temperature rise may consist of a progressive rise from room temperature to the hydrothermal synthesis temperature T₁. According to another form of the invention, the temperature rise may consist of a progressive rise from the temperature at which the container is filled with the slurry to the hydrothermal synthesis temperature T₁;

the cooling time is less than 25 h;

the initial mixture represents a water volume equal to 6 liters and in that the hydrothermal synthesis step is carried out for a time of between 35 and 45 h;

the quicklime is obtained by calcination at a temperature of at least 850° C. for at least one hour of limestone blocks such that at least 90% by weight have a size of 1 to 15 mm, said limestone having a purity of at least 92% by weight and a open porosity ranging from 0 to 25%;

the drying step is carried out at a temperature of 300 to 450° C. for a time of 40 to 200 hours.

The term “purity” is understood to mean the percentage by weight of calcium carbonate in the limestone.

A person skilled in the art will know how to identify the worked quarries or veins enabling the aforementioned limestone blocks to be obtained.

The initial mixture represents a water volume equal to at least 3 liters and at most 50 liters.

Depending on the process for producing such a silico-calcareous packing, especially depending (i) on the choice and quality of the precursors (mainly CaO and SiO₂), (ii) on the temperature, rise time to this temperature, pressure and duration of the hydrothermal synthesis and the temperature drop rate down to room temperature and (iii) on the final drying step, the microstructure of the final porous mass (morphology of the grains/needles, arrangement of the grains/needles, pore size distribution, BET specific surface area (S_{BET}), etc.), and consequently the associated properties (acetone/acetylene storage capacity, gas recovery, etc.), may be greatly affected thereby.

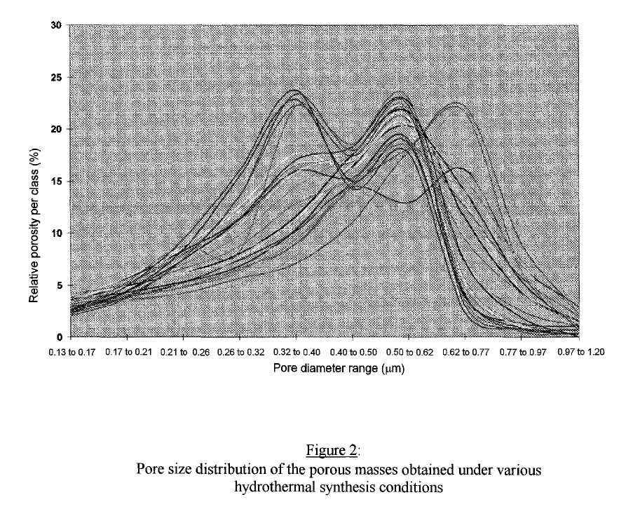

FIG. 2 shows the pore size distribution determined by mercury porosimetry of specimens of microporous masses obtained from production trials carried out for various hydrothermal synthesis parameters (synthesis temperature (180 to 210° C.), rise time to this temperature (1 to 30 hours), synthesis pressure (between 10 and 30 bar), synthesis time (30 to 240 minutes)). In the context of these trials, the temperature drop rate was not modified. This involved a sudden quench, consisting in removing the packed bottles after their synthesis cycle, spraying them with a shower for a fixed time and allowing them to cool down freely to room temperature. The choice of precursors and the drying step were not modified in the context of these trials.

The fact of having modified the operating parameters of the hydrothermal synthesis step results in bottles having greatly affected gas recovery capacities. These major modifications are directly associated with the microstructure of the porous mass, which is itself directly dependent on the production process and in particular, in this specific case, on the hydrothermal synthesis. It should be noted that the thermal conductivity of the solvent-laden silico-calcareous packing is itself very insensitive to the production parameters for all the gas bottles considered, for practically equivalent macrostructures/microstructures. It should also be noted that all the packings, the pore distribution characterization of which is shown in FIG. 3, were subjected to and favorably passed the approval tests in force, defined by the ISO 3807-1 (2000) standard. In particular, all these packings, having a typical final composition of the CaₓSi_{y}O_{z},wH₂O type, and the diameters of the most numerous pores of which being within the 0.3-0.9 μm range, met the requirements of the flash-back test (flammability test), thus guaranteeing the statutory safety of these bottles. Furthermore, the pore distribution of these packings is currently monomodal, or bimodal, that is to say centered around a pore size (or two pore sizes) predominantly encountered within the packing.

A correlation has been observed between the pore distribution and the morphology of the pores (geometric dimensions). The pores are obtained by stacks of micron-sized needles having a length ranging from 1 to 20 μm, a width ranging from 0.1 to 5 μm and a thickness ranging from between 0.01 and 5 μm. These needle dimensions are the direct consequence of the production process and, in the present case, of the hydrothermal synthesis step.

A detailed study was carried out on the impact of the hydrothermal synthesis time (time t₁ of the temperature hold, ranging from 3 to 44 h—all other parameters of the hydrothermal synthesis step being moreover identical (rate of rise, duration of the rise, synthesis pressure, cooling rate)). Likewise, the upstream and downstream steps, namely the limestone treatment conditions, the slurry formulation/preparation and the drying, were strictly the same.

FIG. 3 shows a packing structure specimen synthesized at T₁=196° C. and at P₁=13.8 bar for t₁=3 hours, after a temperature rise lasting Dt₁=5 h and a temperature drop rate ΔTR₁=70° C./min.

FIG. 4 shows a packing structure specimen synthesized at T₁=196° C. and at P₁=13.8 bar for t₁=22 hours, after a temperature rise lasting Dt₁=5 h and a temperature drop rate ΔTR₁=70° C./min.

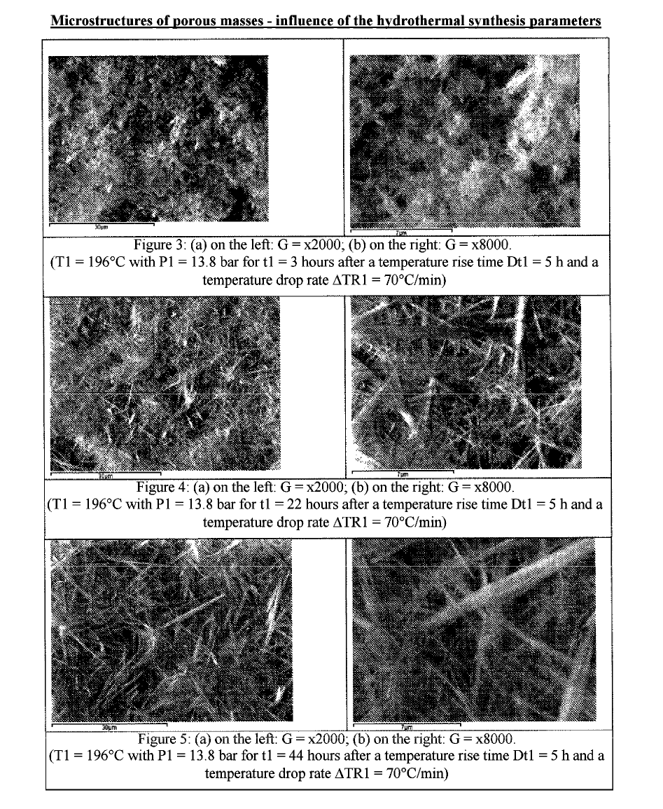

FIG. 5 shows a packing structure specimen synthesized at T₁=196° C. and at P₁=13.8 bar for t₁=44 hours, after a temperature rise lasting Dt₁=5 h and a temperature drop rate ΔTR₁=70° C./min

Each of these three figures was obtained by scanning electron microscopy.

The photographs in FIGS. 4(a-b) show the microstructure of packings obtained from the bottles having gas extraction and safety performance characteristics which were judged to be nonconforming This nonconforming behavior is due to:
the size of the xonotlite/tobermorite needles, generally shorter and thinner, and therefore expressing a less favorable gas flow capability;
the presence of nodules constituting heterogeneities and resulting in too low a mechanical strength of a packing mass and failure in the standardized flammability test; and
the heterogeneity of the compounds (presence of tobermorite, intermediate synthesis product and xonotlite, final crystallized product). This is due directly to the hydrothermal synthesis conditions. The consequence is a microstructure having nonconforming final properties (gas extraction rate, mechanical strength, etc.).

In contrast, the photographs of FIGS. 4 and 5 show a predominantly xonotlite crystalline structure consisting of fine entangled needles. This type of structure meets the requirements of the mechanical strength, gas recovery and safety tests. It corresponds to completed hydrothermal synthesis suitable for producing the intended microstructure, which gives the packings the required properties.

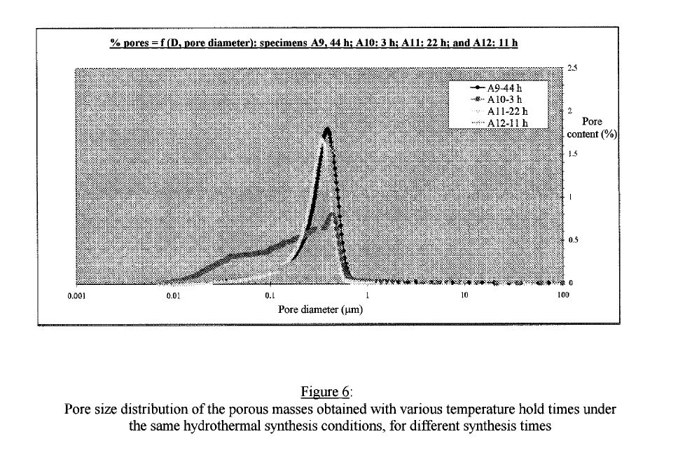

FIG. 6 shows the pore size distribution and Table 1 indicates the characteristics of the specimens produced for various synthesis times t₁: 3, 11, 22 and 44 h.

TABLE 1
Characteristics of the specimens produced for
various synthesis times t₁: 3, 11, 22 and 44 h.

| | Crystallographic phases determined by X-ray diffraction (%) | | | | | | |
|---|---|---|---|---|---|---|---|
| Synthesis | | | Tobermorite | Tobermorite | | % | D₅₀ |
| time t₁ (h) | CaCO₃ | SiO₂ | 11 Å | 9 Å | Xonotlite | porosity | (μm) |
| 3 | ~50 | ~50 | | | | 86.7 | 0.21 |
| 11 | | | ~10 | ~40 | <50 | 87.6 | 0.61 |
| 22 | | | 1-2 | | >98 | 91.5 | 0.35 |
| 44 | | | 3-5 | | >93 | 91.8 | 0.40 |

The improved safety and gas withdrawal properties (steady flow rate and internal pressure in the bottle, amount of gas that can be used) are directly dependent on the parameters of the manufacturing process and, in this particular case, on the hydrothermal synthesis conditions (temperature rise time, temperature, pressure, synthesis time and temperature drop time) described above, which define the crystalline microstructural state of the packings.

The desired packing structure (FIGS. 5 and 6) according to the invention is firstly the consequence of producing a quicklime having a satisfactory reactivity and capable of forming, after hydrothermal synthesis, the desired acicular material (patents S7092 and S7224). The next step of the process consists in mixing the quicklime with silica, which may be amorphous or crystalline, with a CaO/SiO₂ molar ratio of 0.8 to 1. Furthermore, the ratio of water to solid precursors (lime+silica) is preferably between 2 and 60, more preferably between 3 and 25.

The mixture is then introduced into the containers to be packed and undergoes hydrothermal synthesis. To succeed, the hydrothermal synthesis must be carried out:

at a hydrothermal synthesis temperature T₁, which may be between 150 and 300° C., preferably between 180 and 250° C. (see FIG. 2 for the description of the various parameters having an impact on the hydrothermal synthesis step);

at a pressure of between 5×10⁵ Pa and 25×10⁵ Pa (5 and 25 bar), preferably between 7×10⁵ Pa and 15×10⁵ Pa (7 and 15 bar). According to a first embodiment, the synthesis may be carried out by introducing the mixture into the open container that is intended to be packed, and then placing the container in an autoclave oven under the pressure described above. According to a second embodiment, the hydrothermal synthesis may be carried out by placing the mixture in the container that it is intended to pack, closing said container with a plug fitted with a pressure regulation system (such as a valve), pressurizing the container to a pressure ranging from atmospheric pressure to the pressures described above, and then placing this container in an unpressurized oven;

for a time ranging, depending on the volume of the container to be packed, from 10 h to 70 h, for example about 40 hours for a container having a water volume of between 3 and 50 liters, preferably equal to 6 liters;

the temperature rise ΔΔt₁ to T₁ must take place over a time of less than 10 h, preferably less than 2 h. When several containers packed with packing material are placed within the same oven, this parameter takes into account the positioning of the bottles with respect to one another. This is because the bottles are heated by circulation of heated air inside the synthesis oven. This air circulation will depend strongly on the number and position of the bottles placed in the oven. It is necessary to limit the variations in temperature rise time, since this parameter has a direct impact also on the rate of crystallization of the needles of the CaₓSi_{y}O_{z},w.H₂O compounds formed;

the drop from T₁ down to room temperature takes between 1 and 48 h, preferably between 1 and 25 h, depending on the temperature drop rate ΔTR₁.

An optional additional step at this stage of the process may consist in suddenly cooling the bottles by straining them, right from the end of the synthesis cycle (T₁, t₁, P₁) or by quenching in water or an appropriate heat-transfer liquid.

The function of the drying step is not only to remove the residual water but also to give the treated mass a predominantly crystalline structure and thus to perfect the hydrothermal synthesis step. If after hydrothermal synthesis the predominant phase is not the desired xonotlite, and a significant amount of tobermorite and/or residues of the precursor phases (CaO, SiO₂) remain, the drying step may continue the xonotlite crystallization. This drying step is carried out in a conventional electric oven (which may be the same as that used for the hydrothermal synthesis), at atmospheric pressure, i.e. after the plugs and valves have been removed from the top of the containers after hydrothermal synthesis in the second example of hydrothermal synthesis described above.

Another subject of the invention is a container containing a packing structure as described above, which container is capable of containing and delivering a fluid.

The container usually comprises a metal casing containing the packing structure described above. The metal casing may be made of a metallic material such as steel, for example a standardized carbon steel P265NB according to the NF EN10120 standard, the thickness of which enables it to withstand at least the pressure of the hydrothermal synthesis without any risk of an accident and capable of withstanding the 60 bar (6 MPa) proof pressure, this being the statutory pressure for filling with acetylene under the conditions described above. The container is also usually of cylindrical shape and generally provided with closure means and a pressure regulator. This container preferably has a diameter/length ratio of between 0.2 and 0.7, more preferably between 0.35 and 0.5, and a minimum water capacity of one liter. Usually, such a container takes the form of a bottle.

The fluids stored in the packing structure according to the invention may be gases or liquids.

The following gases may be mentioned: pure compressed gases or mixtures of compressed gases in gaseous or liquid form, such as hydrogen, gaseous hydrocarbons (alkanes, alkynes and alkenes), nitrogen and acetylene, and gases dissolved in a solvent, such as acetylene and acetylene/ethylene or acetylene/ethylene/propylene mixtures, dissolved in a solvent such as acetone or dimethylformamide (DMF).

The following liquids may in particular be mentioned: organometallic precursors, such as the Ga and In precursors used in particular in electronics, and also nitroglycerine.

In particular, the container according to the invention contains acetylene dissolved in DMF or in acetone.

The present invention enables the drawbacks of the prior art to be overcome using a specific porous container packing structure formed by an entanglement of crystallites having a particular morphology and a particular size.

The process for producing the packing structure according to the invention enables these crystallites to be obtained. It is essential to control the operating parameters of all the manufacturing steps (treatment of the limestone/formulation/slurry preparation, hydrothermal synthesis, drying). Patent S7092 relates to the limestone calcination/formulation/slurry preparation aspects. Once the CaO—SiO₂—H₂O slurry is conforming, the hydrothermal synthesis step—the subject matter of this patent—makes it possible to obtain a perfectly controlled and adaptable microstructure according to the desired properties (gas storage capacity, recovery rate, mechanical properties, conformity to the flammability tests, reproducibility/reliability of the masses produced on the production machine, etc.).

1-6. (canceled)

7. A process for producing a container packing structure comprising a crystalline phase containing 55 to 97% by weight of xonotlite crystallites and 3 to 45% by weight of tobermorite crystallites, containing less than 15% by weight of intermediates of formula:
CaₓSi_{y}O_{z}, w H₂O with 1<x<16, 1<y<24, 4<z<60 and 1<w<18,
and containing less than 5% by weight of CaCO₃ and less than 5% by weight of SiO₂, said packing structure being homogeneous, characterized in that it comprises the following steps:
a) a temperature rise step, over a time of less than 10 h, during which an initial mixture of quicklime and silica is heated to a temperature T₁ of between 150 and 300° C.;
b) a hydrothermal synthesis step carried out:
using the quicklime/silica mixture resulting from step a),
at a temperature T₁ of between 150 and 300° C.,
at a pressure P₁ of between 5×10⁵ Pa and 25×10⁵ Pa and
for a time t₁ of between 10 h and 70 h;
c) a cooling step, over a time of between 1 and 48 h, in which the mixture obtained from step b) is cooled from the temperature T₁ to room temperature at a cooling rate ΔTR₁ of between 3 and 200° C./hour; and
d) a drying step, in which the mixture obtained from step c) is dried.

8. The process of claim 7, wherein:
in step a), the temperature rise takes place over a time Δt₁ of less than 2 h;
in step b), the temperature T₁ is between 180 and 250° C.; and
in step c), the pressure P₁ is between 7×10⁵ Pa and 25×10⁵ Pa.

9. The process of claim 7, wherein the cooling time is less than 25 h.

10. The process of claim 7, wherein the initial mixture represents a water volume equal to 6 liters and in that the hydrothermal synthesis step is carried out for a time of between 35 and 45 h.

11. The process of claim 7, wherein the quicklime is obtained by calcination at a temperature of at least 850° C. for at least one hour of limestone blocks, wherein are at least 90% by weight of the limestone blocks have a size of 1 to 15 mm, said limestone in the limestone blocks having a purity of at least 92% by weight and a open porosity ranging from 0 to 25%.

12. The process of claim 7, wherein the drying step is carried out at a temperature of 300 to 450° C. for a time of 40 to 200 hours.
